(19) United States
(12) Patent Application Publication
(10) Pub. No.: US 2008/0295104 A1
(43) Pub. Date: Nov. 27, 2008

(54) Realtime Processing Software Control Device and Method

(75) Inventors: Yutaka Fujihara, Osaka (JP); Takuya Nomura, Osaka (JP); Shusuke Haruna, Hyogo (JP); Hisaki Furuyama, Osaka (JP); Musubi Uno, Osaka (JP); Hirokazu Yamamoto, Osaka (JP); Jie Lin, Hyogo (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma (JP)

(21) Appl. No.: 11/658,175

(22) PCT Filed: Jul. 22, 2005
(86) PCT No.: PCT/JP05/13514

§ 371 Date: Apr. 9, 2007

(30) Foreign Application Priority Data
Jul. 23, 2004 (JP) 2004-216343

(51) Int. Cl. G06F 9/46

(52) U.S. Cl. 718/103

(57) ABSTRACT

There is provided a realtime processing software control method in which the priorities of plural states can be relatively described according to the necessities of realtime processing for the respective states, and design of state transitions and task priorities considering realtime property can be performed in the upstream design stage before specific execution times are clarified. For the respective states ([1]311˜[6]316) the control target equipment can take, realtime property flags (F1˜F6) indicating whether the processings in the respective states require realtime processing or not, and priority levels (P1˜P6) that are determined by the immediately preceding state and the current state, are set, and a task priority management unit (104) changes the priority of the task on the basis of the realtime property flag and the priority level, with the state transition of the control target equipment.

### TECHNICAL FIELD

The present invention relates to a realtime processing software control device intended to be incorporated in an equipment, and a control method thereof.

### BACKGROUND APT

As a control method by a conventional realtime processing software intended to be incorporated in an equipment, Japanese Published Patent Application No. 2003-131892 (Patent Document 1) discloses a task execution control method which performs task scheduling by changing the priorities of tasks on the basis of execution times for executing tasks that are previously determined.

Hereinafter, the conventional task execution control method will be described.

FIG. 5 is a diagram for explaining the conventional task execution control method.

With reference to FIG. 5, character A denotes an execution environment for tasks. The execution environment A includes a hardware layer A1, an operation system (OS) layer A2, and an application layer A3 operating on the OS layer A2.

The hardware layer A1 includes hardware resources such as a central processing unit (CPU) 506, a memory 507, and a graphic device 508.

The application layer A3 includes plural tasks which are executed with the execution of the applications. FIG. 5 shows a task A509, a task B510, and a task C511 as tasks in the application layer A3. The task A is characterized by being repeatedly executed in predetermined periods, and it has the highest priority among tasks A to C. The task B is a task that is executed by using a common resource (hereinafter referred to as “semaphore”) that is common to task A and task B, and it is characterized by that the occupation time length of the semaphore that is required for executing the task processing is fixed. The task B has the lowest priority among tasks A to C. The task C shares no resource with tasks A and B, and it has the 2nd-highest priority among tasks A to C.

Further, a task execution control device 500 performs a processing relating to scheduling of tasks, as a part of a kernel that is included in the OS layer A2. That is, the task execution control device 500 includes a scheduling unit 501 which controls the execution order of a task A509, a task B510, and a task C511, a management unit 502 which performs a processing for avoiding reversal of the priorities that is associated with an exclusive control of the task semaphore or a task interruption, and a time margin calculation unit 503 which calculates a time margin that is time information to be referred when the scheduling unit 501 performs the task execution order control. Here, the time margin is the temporal margin from when the task C511 releases the semaphore to when execution of the task A509 is started, and this is calculated by the following formula (1).

time margin=scheduled execution start time of task A−semaphore releasing time of task B

Further, the management unit 502 includes a semaphore management unit 504 which performs a processing relating to the exclusive control of the task semaphore, and a priority management unit 505 which controls the priorities of the tasks in association with a task interruption.

Next, the operation will be described.

When the task B510 issues a semaphore acquisition request to the semaphore management unit 504, the time margin calculation unit 503 calculates a time margin according to an instruction from the semaphore management unit 504.

When the above-mentioned time margin is a negative value, the semaphore management unit 504 does not allow the occupation of the semaphore by the task B510, and notifies the scheduling unit 501 of that effect. The scheduling unit 501 sets the task B510 in a stand-by state, and executes a processing of the task B510 after completion of processing of the task A509. On the other hand, when the above-mentioned time margin is a positive value, the semaphore management unit 504 allows the occupation of the semaphore by the task B510, and notifies the scheduling unit 501 of that effect. On receipt of this notification, the scheduling unit 501 sets the task B510 in an operating state.

When the scheduling unit 501 receives an execution start request from the task C511 during the operation of the task B510, the priority management unit 505 obtains information relating to the time margin from the semaphore management unit 504. Then, the priority management unit 505 sets an allowable time with this time margin as an initial value, and sends a priority change instruction including the allowable time, to the scheduling unit 501.

On receipt of the priority change instruction, the scheduling unit 501 measures the time elapsed from the execution start of the task C511 as an interrupt processing time, and waits for completion of the task C511 while checking that the interrupt processing time does not exceed the allowable time. The scheduling unit 501 sets the task B510 in an operating state when the task C511 completes the processing within the range of the allowable time. On the other hand, when the processing of the task C511 continues until reaching the allowable time, the scheduling unit 501 raises the priority of the task B510 up to the same level as the task A509 according to the priority change instruction. Thereby, when an interrupt processing by the task C511 occurs, the priority of the task B510 is raised up to the same priority as the task A509 at the timing when the interrupt processing time reaches the length of the time margin, and thereby “priority reversing phenomenon” in which the processing of the task B510 is delayed due to the interruption of the task C511 is avoided.

### DISCLOSURE OF THE INVENTION

### Problems to be Solved by the Invention

In the control method using the conventional realtime processing software, the priorities of the tasks are changed on the basis of the execution times of the tasks which are previously determined, to perform task scheduling as described above, and therefore, when designing the realtime processing software, the execution times of the respective tasks must be previously determined at the stages of designing the control target equipment.

However, it is very difficult to determine specific values of the execution times of the tasks until the final stage of the design at which the details of the design are determined, and further, the execution times of the tasks are not usually included in the design contents in the upstream design stage based on the equipment specification. Therefore, in the conventional control method using the realtime processing software, it is very difficult to previously perform sufficient software design for performing realtime processing.

The present invention is made to solve the above-mentioned problems and has for its object to provide a realtime processing software control device and method which can realize software design considering realtime property from the preliminary design stage, and can flexibly change the task priorities during program execution, by associating information as to whether realtime processing is required or not with the state transition of the equipment based on the equipment specification, and automatically changing the priorities of the tasks concurrently with the state transition of the equipment.

### Measures to Solve the Problems

According to claim 1 of the present invention, there is provided a realtime processing software control method for controlling execution of tasks corresponding to the respective operation states of an equipment having plural operation states, on the basis of priorities that are set for the respective tasks, and the method includes a priority updation step of updating, every time the state of the equipment transits, the priority of the task corresponding to the operation state of the equipment after the transition.

According to claim 2 of the present invention, in the realtime processing software control method defined in claim 1, the priority updation step is a step of updating the priority on the basis of a priority level value that is set for each of the plural operation states of the equipment.

According to claim 3 of the present invention, in the realtime processing software control method defined in claim 2, the priority level value is a value that is determined by the state of the equipment immediately before the transition and the state of the equipment after the transition.

According to claim 4 of the present invention, in the realtime processing software control method defined in claim 1, the priority updation step includes a judgment step of judging, every time the state of the equipment transits, the necessity of realtime processing for the task corresponding to the operation state of the equipment after the transition, and only when it is judged in the judgment step that realtime processing is necessary, the priority of the task corresponding to the operation state of the equipment after the transition is updated.

According to claim 5 of the present invention, in the realtime processing software control method defined in claim 4, the judgment step judges the necessity of realtime processing for the task corresponding to the state of the equipment after the transition, on the basis of a realtime property flag indicating the necessity of realtime processing, which flag is set for each of the plural operation states of the equipment.

According to claim 6 of the present invention, there is provided a realtime processing software control device for performing execution control of tasks corresponding to the respective states of an equipment having plural operation states, on the basis of the priorities that are set for the respective tasks, and the device includes a task priority management unit for updating, every time the state of the equipment transits, the priority of the task corresponding to the operation state of the equipment after the transition.

According to claim 7 of the present invention, the realtime processing software control device defined in claim 6 further includes a priority level table storage unit which stores priority level tables in which the states of the equipment immediately before transitions correspond to updation parameter values of the priorities, which tables are set for the respective operation states of the equipment, and the task priority management unit reads, every time the state of the equipment transits, the updation parameter value corresponding to the state of the equipment immediately before the transition, from the priority level table that is set for the state after the transition with reference to the priority level table storage unit, and updates the priority of the task corresponding to the operation state of the equipment after the transition on the basis of the read updation parameter value.

According to claim 8 of the present invention, the realtime processing software control device defined in claim 6 or 7 further includes a realtime property flag holding unit which holds realtime property flags indicating the necessities of realtime processing for the tasks corresponding to the respective operation states of the equipment, and the task priority management unit reads, every time the state of the equipment transits, the realtime property flag corresponding to the state of the equipment after the transition from the realtime property flag holding unit, judges the necessity of realtime processing for the task corresponding to the state, and updates the priority of the task corresponding to the state of the equipment after the transition only when it is judged that realtime processing is necessary.

### EFFECTS OF THE INVENTION

According to the invention of claim 1, there is provided a realtime processing software control method for controlling execution of tasks corresponding to the respective operation states of an equipment having plural operation states, on the basis of the priorities that are set to the respective tasks, wherein, every time the state of the equipment transits, the priority that is set to the task corresponding to the operation state of the equipment after the transition is updated. Therefore, it is possible to realize software design considering realtime property from the preliminary design stage, whereby the task priorities during program execution can be flexibly changed.

According to the invention of claim 2, in the realtime processing software control method defined in claim 1, the priority updation step updates the priority on the basis of a priority level value that is set for each of the plural operation states of the equipment. Therefore, the priorities of the tasks can be dynamically and automatically changed concurrently with the state transitions, whereby design of the priorities during task execution can be carried out in synchronization with design of the state transitions, on the basis of the actual operation state, from the upstream design stage of the equipment having the plural operation states. Further, since description of the priorities for the respective state transitions is carried out in advance, it becomes unnecessary to perform the task priority design in the post-stage of the device design.

According to the invention of claim 3, in the realtime processing software control method defined in claim 2, the priority level value is determined by the state of the equipment immediately before the transition and the state of the equipment after the transition. Therefore, the priorities of the respective states can be relatively described, whereby it is possible to perform design of the state transitions and the task priorities considering the realtime property, in the upstream design stage before the details of the task execution times of the control target equipment are clarified.

According to the invention of claim 4, in the realtime processing software control method defined in claim 1, the priority updation step includes a judgment step of judging, every time the state of the equipment transits, the necessity of realtime processing for the task corresponding to the operation state of the equipment after the transition, and only when it is judged in the judgment step that realtime processing is necessary, the priority of the task corresponding to the operation state of the equipment after the transition is updated. Therefore, it is possible to avoid updation of priority for the task that does not require realtime processing.

According to the invention of claim 5, in the realtime processing software control method defined in claim 4, the judgment step judges the necessity of realtime processing for the task corresponding to the state of the equipment after the transition, on the basis of a realtime property flag indicating the necessity of realtime processing, which flag is set for each of the plural operation states of the equipment. Therefore, the judgment of necessity of realtime processing for the task is simplified.

According to the invention of claim 6, there is provided a realtime processing software control device for performing execution control of tasks corresponding to the respective states of an equipment having plural operation states, on the basis of the priorities that are set for the respective tasks, and the device includes a task priority management unit for updating, every time the state of the equipment transits, the priority of the task corresponding to the operation state of the equipment after the transition. Therefore, it is possible to realize software design considering realtime property from the preliminary design stage, whereby the task priorities during program execution can be flexibly changed.

According to the invention of claim 7, the realtime processing software control device defined in claim 6 further includes a priority level table storage unit which stores priority level tables in which the states of the equipment immediately before transitions correspond to updation parameter values of the priorities, which tables are set for the respective operation states of the equipment, and the task priority management unit reads, every time the state of the equipment transits, the updation parameter value corresponding to the state of the equipment immediately before the transition, from the priority level table that is set for the state after the transition with reference to the priority level table storage unit, and updates the priority of the task corresponding to the operation state of the equipment after the transition on the basis of the read updation parameter value. Therefore, the priorities of the tasks can be dynamically and automatically changed concurrently with the state transitions, whereby design of the priorities during task execution can be carried out in synchronization with design of the state transitions, on the basis of the actual operation state, from the upstream design stage of the equipment having the plural operation states. Further, since description of the priorities for the respective state transitions is carried out in advance, it becomes unnecessary to perform the task priority design in the post-process of the device design.

According to the invention of claim 8, the realtime processing software control device defined in claim 6 or 7 further includes a realtime property flag holding unit which holds realtime property flags indicating the necessities of realtime processing for the tasks corresponding to the respective operation states of the equipment, and the task priority management unit reads, every time the state of the equipment transits, the realtime property flag corresponding to the state of the equipment after the transition from the realtime property flag holding unit, judges the necessity of realtime processing for the task corresponding to the state, and updates the priority of the task corresponding to the state of the equipment after the transition only when it is judged that realtime processing is necessary. Therefore, updation of priority for the task that does not require realtime processing can be avoided by simple judgment.

### BRIEF DESCRIPTION OF THE DRAWINGS

FIG. 1 is a diagram illustrating the construction of a realtime processing software control device according to a first embodiment of the present invention.

FIG. 2 is a diagram for explaining a priority level table according to the first embodiment, illustrating the internal structure of the priority level table;

FIG. 3(a) is a schematic diagram for explaining the outline operation of the realtime processing software control device according to the first embodiment.

FIG. 3(b) a diagram for explaining a priority level table according to the first embodiment, illustrating the specific internal structure of the priority level table.

FIG. 4 is a flowchart for explaining the operation of the realtime processing software control device according to the first embodiment.

FIG. 5 is a schematic diagram for explaining the conventional task execution control method.

### DESCRIPTION OF REFERENCE NUMERALS

101 . . . state transition execution unit
102 . . . realtime property flag holding unit
103 . . . priority level table storage unit
104 . . . task priority management unit
105 . . . state transition management unit
106 . . . task priority updation unit
201 . . . priority level value holding unit
F(1)˜F(5) . . . realtime property flags
Pk(1), Pk(2), Pk(n) . . . priority level values
T(k) . . . priority level table
Tp(n) . . . task priority
Ts(n) . . . task
X(1)˜X(n) . . . immediately preceding state index values

### BEST MODE TO EXECUTE THE INVENTION

Hereinafter, an embodiment of the present invention will be described.

### Embodiment 1

A software control device according to a first embodiment of the present invention performs execution control for tasks corresponding to the respective states of an equipment having plural operation states, on the basis of the priorities that are set for the respective tasks. In the software control device according to the present invention, every time the state of the control target equipment transits, the priority that is set to the task corresponding to the operation state after the transition is updated.

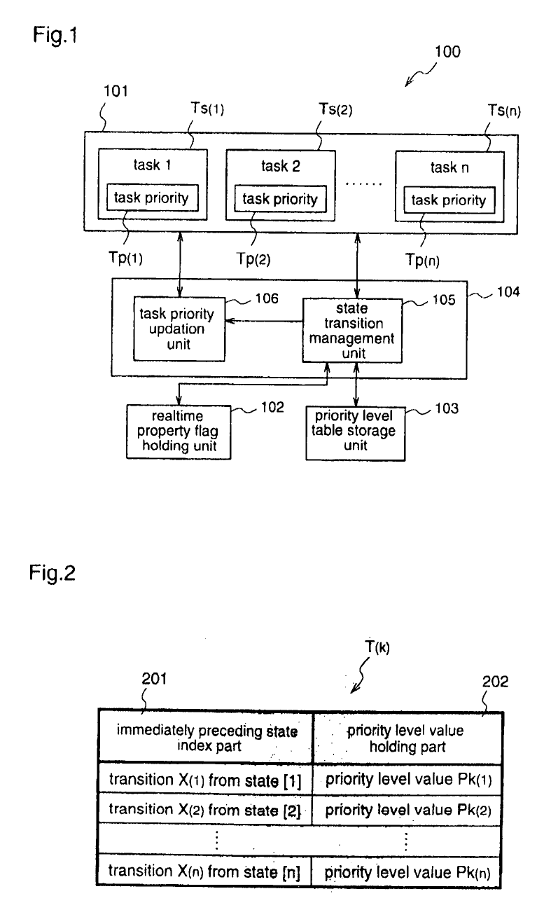

FIG. 1 is a schematic diagram illustrating the construction of the realtime processing software control device according to the first embodiment of the present invention.

With reference to FIG. 1, the realtime processing software control device 100 includes a state transition execution unit 101, a realtime property flag holding unit 102, a priority level table storage unit 103, and a task priority management unit 104.

The state transition execution unit 101 executes tasks Ts(1)˜Ts(n) corresponding to the respective states of an equipment having plural operation states. The equipment having plural operation states is, for example, an AV equipment such as a video tape recorder or a DVD player, and the plural operation states of this equipment are the stop state, playback state, recording state, fast-forward state, and the like. Hereinafter, the states of the control target equipment are indicated by state [1], state [2], . . . , state [n] (n: integer). The tasks Ts(1)˜Ts(n) corresponding to the states [1]˜[n] of the equipment are assigned task priorities Tp(1)˜Tp(n) indicating how much degree of priority with which each task should be operated relative to other tasks.

The realtime property flag holding unit 102 holds a realtime property flag F(i) indicating whether realtime processing should be performed or not when the control target equipment is in the state [i] (i=1˜n). The realtime property flag F(i) is set for each of the respective states [1]˜[n], and realtime property flags F(1)˜F(n) corresponding to the states [1]˜[n] of the equipment are stored in the realtime property flag holding unit 102.

The priority level table storage unit 103 stores priority level tables T(1)˜T(n) in which the states of the equipment immediately before state transitions are associated with the priority level values that are the parameter values for changing the task priorities Tp(1)˜Tp(n) of the tasks Ts(1)˜Ts(n), which tables are set for the respective states [1]˜(n) of the equipment. That is, the priority level tables T(1)˜T(n) corresponding to the respective states [1]˜[n] of the equipment are stored in the priority level table storage unit 103.

A description will be given of the detail of the priority level table T(i).

FIG. 2 is a diagram illustrating the specific construction of the inside of the priority level table T(i).

The priority level table T(i) comprises an immediately preceding state index part 201, and a priority level value holding part 202 which holds priority level values corresponding to the immediately preceding states, and it is set according to the operation state [i] of the equipment.

The values indicated in the immediately preceding state index part 201 of the priority level table T(i) are index values X(1), X(2), . . . , X(n) indicating the operation states [1], [2], . . . , [n] that have occurred immediately before the control target equipment transits to the current state [k]. Further, the values in the priority level value holding part 202 of the priority level table T(i) are individual priority level values Pk(1), Pk(2), . . . , Pk(n) that are obtained when the equipment transits from the immediately preceding states [1], [2], . . . , [n] to the current state [k], respectively, and the immediately preceding state index value X(n) in the immediately preceding state index part and the priority level value Pk(n) in the priority level value holding part 202 are treated in pairs.

Next, the task priority management unit 104 shown in FIG. 1 updates the task priority Tp(k) of the task Ts(k) corresponding to the current state [k] every time the operation state of the equipment transits. The task priority management unit 104 comprises a state transition management unit 105 and a task priority updation unit 106 as shown in FIG. 1, and the state transition management unit 105 monitors the current state [k] of the control target equipment and the immediately preceding operation state thereof, and reads the realtime property flag F(k) that is associated with the current state [k] from the realtime property flag storage unit 102 to judge the necessity of realtime processing. Further, the state transition management unit 105 accesses the priority level table storage unit 103, and reads the priority level values Pk(k) corresponding to the current state and the immediately preceding state, from the priority level table T(k) corresponding to the current state [k].

The task priority updation unit 106 updates the task priority Tp(k) of the task Ts(k) corresponding to the current state [k], on the basis of the priority level values Pk(k) outputted from the state transition management unit 105.

The realtime processing software control device 100 constituted as described above can be implemented by a hierarchical structure which is composed of a hardware layer comprising a CPU, a memory, and the like, a realtime OS layer, and an application layer operating on the realtime OS layer. The state transition execution unit 101 is implemented as a part of the application layer, the task priority management unit 104 is implemented as a part of the realtime OS layer, and the priority level table storage unit 103 and the realtime property flag holding unit 102 are implemented by allocating parts of the memory of the hardware layer, respectively.

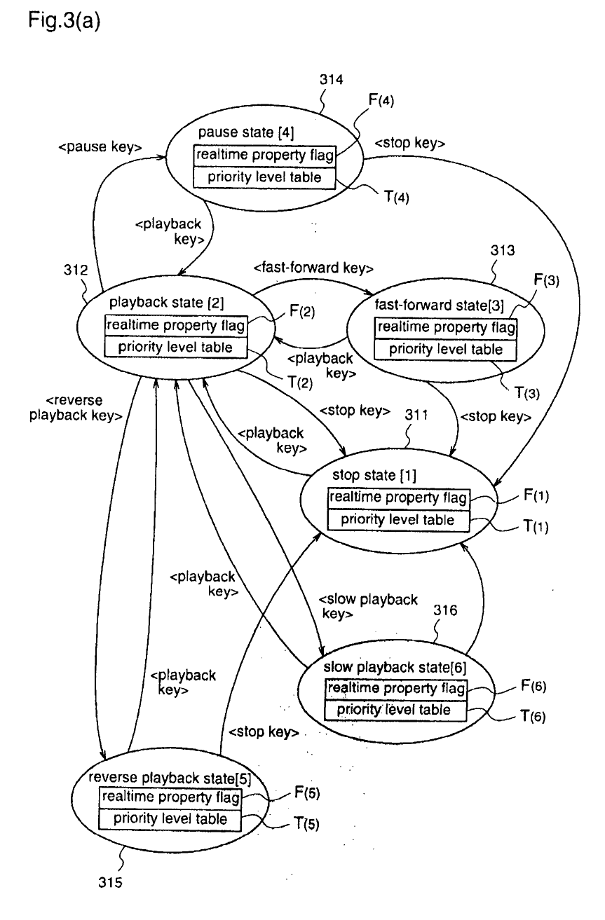

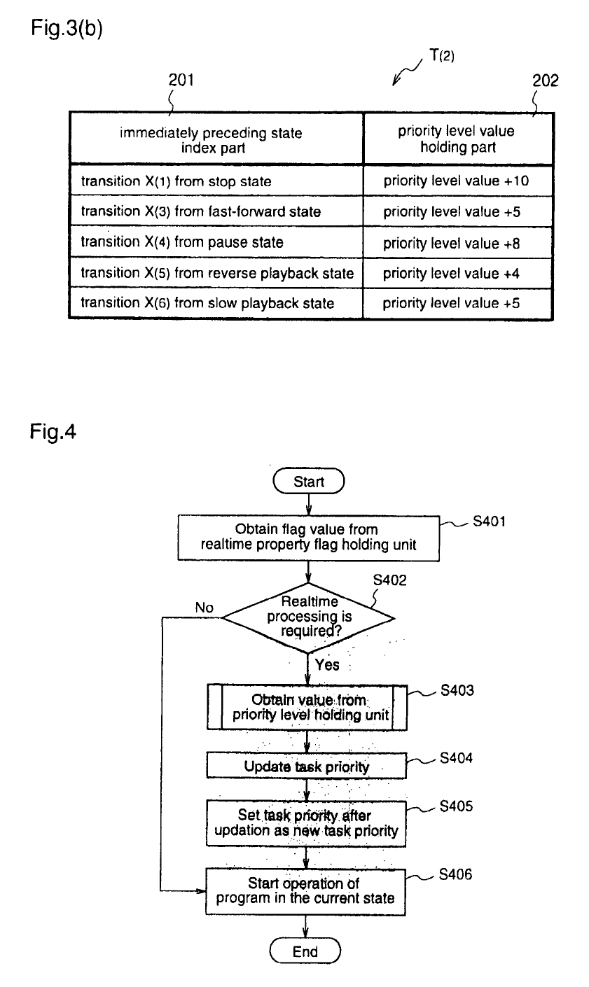

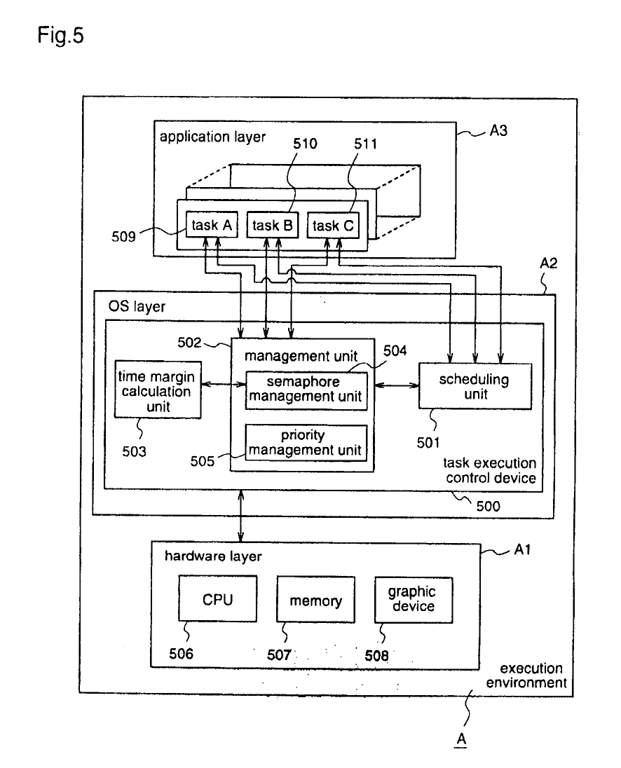

FIG. 3(a) is a diagram illustrating examples of transitions of operation states in the case where the control target equipment is a DVD player, and it schematically shows how the task priority management unit 104 manages the operation transitions of the stop state [1] 311, playback state [2] 312, fast-forward state [3] 313, pause state [4] 314, reverse playback state [5] 315, and slow playback state [6] 316 of the DVD player.

FIG. 3(b) is a diagram illustrating an example of a specific internal structure of the priority level table in the case where the DVD player is in its playback state.

FIG. 4 illustrates the process of updating the task priority Tp(n) when the operation state of the equipment transmits from a certain state to a next state.

Next, the operation of the first embodiment will be described with reference to FIGS. 1 to 4.

Now assuming that the control target equipment is a DVD player, the operation state thereof transits with various command inputs by user's button operation or the like. For example, the operation state transits from the stop state [1] to the playback state [2] as shown in FIG. 3(a) by pressing a playback key (button) that is provided on a controller (not shown). At this time, as a transition condition, if a parental lock or the like is put on, the operation state transits to the playback state only when this lock is released. Likewise, the operation state transits, from the playback state [2], to the fast-forward state [3] performing high-speed playback by pressing a fast-forward key, to the pause state [4] repeating reproduction of the same frame by pressing a pause key, to the reverse playback state [5] performing playback in the reverse direction to the normal playback by pressing a reverse playback key, and to the slow playback state [6] performing playback at a lower speed than the normal playback by pressing a slow playback key, respectively. Further, the fast-forward state [3], the pause state [4], the reverse playback state [5], and the slow playback state [6] respectively transit to the playback state [2] by pressing the playback key. Further, the playback state [2], the fast-forward state [3], the pause state [4], the reverse playback state [5], and the slow playback state [6] respectively transit to the stop state [1] by pressing the stop key.

Here, each state of the state transitions of the DVD player, the necessity of realtime processing for each state, and the priority level value in each state can be vectorially represented as (state, necessity of realtime processing, priority level value).

According to this notation method, when the current state is the playback state and the state immediately before the current state is any of “stop”, “playback”, “pause”, “reverse playback”, and “slow playback” as shown in FIG. 3(b), the respective states can be represented as follows:

(stop, unnecessary, +10)

(playback, necessary, 0)

(fast-forward, necessary, +5)

(pause, unnecessary, +8)

(reverse playback, necessary, +4)

(slow playback, necessary, +5)

When the state of the equipment transits, initially the state transition management unit 105 judges the state after the transition, and obtains the realtime property flag F(k) corresponding to the current state [k] from the realtime property flag holding unit 102 (step S401). Subsequently, the state transition management unit 105 judges whether the current state [k] requires realtime processing or not, using the obtained realtime property flag F(k) (step S402).

When it is judged that the current state [k] requires realtime processing, the state transition management unit 105 obtains the priority level value Pk(i) in the priority level table T(k) corresponding to the current state [k], from the priority level table storage unit 103 (step S403). The priority level value Pk(i) in the priority level table T(k) is a value that varies depending on which of the states [1]˜[n] the state before the transition was, and the obtained priority level value Pk(i) varies depending on the state of the equipment before the transition.

Then, the state transition management unit 105 outputs the priority level value Pk(i) obtained in step S403 to the task priority updation unit 106.

The task priority updation unit 106 adds the priority level value Pk(i) outputted from the state transition management unit 105 to the task priority Tp(k) that is held by the task Ts(k) corresponding to the current state [k], thereby updating the task priority Tp(k) to a new task priority (step S404). Further, the task priority updation unit 106 sets the new task priority obtained in step S404 as the task priority Tp(k) of the current task.

The priority level value Pk(i) that is held in the priority level table T(k) has a positive value when the current state requires realtime processing with higher priority relative to the state immediately before the current state, while it has a negative value when the current state requires realtime processing but its priority for realtime processing is lower than that of the immediately preceding state. Further, when realtime processing is required more strongly in the current state relative to the immediately preceding state, the priority level value Pk(i) is a positive value having a large absolute value. Conversely, when realtime processing is required less strongly in the current state relative to the immediately preceding state, the priority level value Pk(i) is a negative value having a large absolute value.

After the priority of the task suited to the new state is set through the steps from S401 to S405 as described above, the operation unit such as a CPU (not shown) performs the processing that is actually required in the current state [k] (step S406).

Thereafter, every time the state of the equipment transits, the same processes as performed in steps S401˜S406 are carried out, and the priority of the task is dynamically and automatically changed concurrently with the state transition.

Hereinafter, the specific operation of the realtime processing software control device 100 according to the first embodiment will be described for the case where the DVD player transits from the stop state to the playback state.

As described above, the respective states from the stop state [1] 311 to the slow playback state [6] 316 are associated with the realtime priority flags F(1)˜F(6), and the priority level tables T(1)˜T(6), respectively, which correspond to the respective states. Further, the respective states from the stop state [1] 311 to the slow playback state [6] 316 hold equipment control programs to be performed in the respective states, transition destination information indicating the states to which the respective states should transit next due to signal inputs as triggers for state change, and information of transition conditions, although these are not illustrated.

The state transition management unit 105 monitors the state transition of the operation state, and obtains the realtime priority flag corresponding to the current state.

When the playback key is operated in the stop state and thereby the operation state of the DVD player transits from the stop state [1] 311 to the playback state [2] 312, the state transition management unit 105 in the task priority management unit 104 reads the realtime property flag F(2) corresponding to the playback state [2] 312 as the current state from the realtime property flag holding unit 102 to obtain “(realtime processing) required” as the realtime property flag F(2) corresponding to the playback state (state [2]) as the current state (step S401).

The state transition management unit 105 judges the necessity of realtime processing for the playback state [2] 312 (step S402). Since the state transition management unit 105 obtains “(realtime processing) required” as the realtime property flag F(2), it judges that the flag which is set for the playback state [2] 312 indicates the necessity of realtime processing, and accesses the priority level table storage unit 103 to access the priority level table T(2) corresponding to the playback state [2] 312 among the plural priority level tables stored in the priority level table storage unit 103.

The state transition management unit 105 reads, from the priority level table T(2), “+10” as the priority level value Pk(2) corresponding to the transition X(1) from the stop state [1] 311 that is the immediately preceding state (step S403), and outputs the read priority level value to the task priority updation unit 106.

The task priority updation unit 106 updates the task priority of the task corresponding to the current state. For example, the task priority updation unit 106 adds the priority level value “+10” outputted from the state transition management unit 105, to the task priority Tp(2) of the task Ts(2) corresponding to the playback state [2] 312, and sends the value of the task priority Tp(2) of the task Ts(2) to the task priority updation unit 106. The task priority updation unit 106 adds the value “+10” of the priority level value Pk(2) as an increment value to the task priority Tp(2) of the task Ts(2), thereby updating the task priority (steps s404, S405). As a result, the task priority of the task Ts(2) is raised, and the task Ts(2) becomes more likely to be executed with priority relative to the state before the state transition.

Thereby, the task priority Tp(2) of the task Ts(2) corresponding to the playback state [2] 312 is dynamically and automatically updated concurrently with the state transition of the DVD player. The state transition execution unit 101 starts the operation of the program in the operation state corresponding to the task according to the task priority that is dynamically and automatically changed (step S406).

As described above, according to the first embodiment, the realtime property flag F(i) indicating, for each of the states the control target equipment can take, whether the processing to be performed in that state requires realtime processing or not, and the priority level value Pk(i) that is determined by the immediately preceding state and the current state, are set, and the priority of the task is changed on the basis of the realtime property flag F(i) and the priority level value Pk(i), concurrently with the state transition of the control target equipment. Therefore, the priorities of the respective states can be relatively described according to the necessities of realtime processing for the respective states. As a result, it is possible to perform design of the state transitions and the task priorities considering the realtime property, in the upstream design stage before the specific execution times are clarified.

While in this first embodiment the priority level value Pk(i) is a relative value that is determined by the immediately preceding operation state and the current state [k], the priority level value Pk(i) may be an absolute value that is determined by only the current operation state.

Further, while in the first embodiment the task whose task priority is to be changed is a self task on which state transition occurs, the task whose task priority is to be changed may be one or plural tasks other than the self task on which state transition occurs.

### APPLICABILITY IN INDUSTRY

The present invention is useful as an incorporated software control method for an equipment that has plural operation states, and must change the task priority for each state, such as a video tape recorder or a DVD player.

1. A realtime processing software control method for controlling execution of tasks corresponding to the respective operation states of an equipment having plural operation states, on the basis of priorities that are set for the respective tasks, said method including:
a priority updation step of updating, every time the state of the equipment transits, the priority of the task corresponding to the operation state of the equipment after the transition.

2. A realtime processing software control method as defined in claim 1 wherein said priority updation step is a step of updating said priority on the basis of a priority level value that is set for each of the plural operation states of the equipment.

3. A realtime processing software control method as defined in claim 2 wherein said priority level value is a value that is determined by the state of the equipment immediately before the transition and the state of the equipment after transition.

4. A realtime processing software control method as defined in claim 1 wherein
said priority updation step includes a judgment step of judging, every time the state of the equipment transits, the necessity of realtime processing for the task corresponding to the operation state of the equipment after the transition, and
only when it is judged in the judgment step that realtime processing is necessary, the priority of the task corresponding to the operation state of the equipment after the transition is updated.

5. A realtime processing software control method as defined in claim 4 wherein said judgment step judges the necessity of realtime processing for the task corresponding to the state of the equipment after the transition, on the basis of a realtime property flag indicating the necessity of realtime processing, which flag is set for each of the plural operation states of the equipment.

6. A realtime processing software control device for controlling execution of tasks corresponding to the respective operation states of an equipment having plural operation states, on the basis of priorities that are set for the respective tasks, said device including:
a task priority management unit for updating, every time the state of the equipment transits, the priority of the task corresponding to the operation state of the equipment after the transition.

7. A realtime processing software control device as defined in claim 6 further including:
a priority level table storage unit which stores priority level tables in which the states of the equipment immediately before transitions correspond to the updation parameter values of the priorities, which tables are set for the respective operation states of the equipment;
wherein said task priority management unit reads, every time the state of the equipment transits, the updation parameter value corresponding to the state of the equipment immediately before the transition, from the priority level table that is set for the state after the transition with reference to the priority level table storage unit, and updates the priority of the task corresponding to the operation state of the equipment after the transition on the basis of the read updation parameter value.

8. A realtime processing software control device as defined in claim 6 further including:
a realtime property flag holding unit which holds realtime property flag indicating the necessities of realtime processing for the tasks corresponding to the respective operation states of the equipment;
wherein said task priority management unit reads, every time the state of the equipment transits, the realtime property flag corresponding to the state of the equipment after the transition from the realtime property flag holding unit, judges the necessity of realtime processing for the task corresponding to the state, and updates the priority of the task corresponding to the state of the equipment after the transition only when it is judged that realtime processing is necessary.

9. A realtime processing software control device as defined in claim 7 further including:
a realtime property flag holding unit which holds realtime property flags indicating the necessities of realtime processing for the tasks corresponding to the respective operation states of the equipment;
wherein said task priority management unit reads, every time the state of the equipment transits, the realtime property flag corresponding to the state of the equipment after the transition from the realtime property flag holding unit, judges the necessity of realtime processing for the task corresponding to the state, and updates the priority of the task corresponding to the state of the equipment after the transition only when it is judged that realtime processing is necessary.
